(19) United States
(12) Patent Application Publication
(10) Pub. No.: US 2009/0319574 A1
(43) Pub. Date: Dec. 24, 2009

(54) USER PROGRAMMABLE INTERNET BROADCAST STATION

(76) Inventors: Clark Burgard, Greenwich, CT (US); Robert Bayne, Rowayton, CT (US)

Correspondence Address: JAMES F MCLAUGHLIN, 11 Ashwood Lane, Brookfield, CT, 06804, US

(21) Appl. No.: 12/491,221

(22) Filed: Jun. 24, 2009

Related U.S. Application Data
(60) Provisional application No. 61/075,206, filed on Jun. 24, 2008.

(51) Int. Cl. G06F 17/00; G06F 15/177

(52) U.S. Cl. 707/104.1; 709/221

(57) ABSTRACT

An apparatus and method for creating a personal radio or television station for broadcasting over the Internet includes a user logging onto a dedicated server on the Internet, creating a personal account associated with memory storage and a unique companion webpage address, selecting audio and or video content from predetermined server play lists including news, music, sports, weather, traffic, emergency and civic announcements. The server operator secures licenses from content providers for rebroadcast rights. The user may also upload personal audio or video content to the server. The user creates his own playlist for broadcast which may include server content or his own personal content. A ‘live mode’ is also presented where a user may stream live audio and or video content from his own broadcast studio to the server for rebroadcast over the webpage. Streaming protocols are used to broadcast content to multiple listeners and prevent copyright violations.

### CROSS-REFERENCE TO RELATED APPLICATIONS

This application claims priority benefit of a U.S. Provisional Application, Ser. No. 61/075,206 filed in the United States Patent and Trademark Office on Jun. 24, 2008, and entitled “User Programmable Internet Broadcast Station”.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

1. Field of the Invention

This invention relates to the programming and delivery of Internet content, and in particular to designing a personal radio station including a variety of audio content, a personal television station including a variety of video content, or a mixture thereof, all designed and programmed by a user for a private use or web-broadcast over the internet to others.

2. Description of Prior Art

Online banking-consumers want access to their banking information from anywhere. This saves having to carry documents on their person or having to be at home to pay bills. Now much of personal banking can be conducted by a consumer anywhere he can access the internet

Telco-based voice mail. This service allows virtually unlimited features across several phone lines. There are far more options than a home-based answering machine.

TIVO® (subscription service with a personal digital video recorder). Consumers want to watch TV on their own schedule, not the schedule of the cable company.

DVRs (digital video recorder). Again consumers want to consume programming on their own schedule, and further with TIVO or a DVR, they can decide what content to watch and in what order. They become the ‘programmer’.

Traditional AM, FM and satellite radio stations provide programming to listeners in a single stream of content. To paint a visual picture of such, the programming appears to the listener as an infinitely long train where each train car (element) follows the next in an order chosen by the programmers. There is an inherent “waiting time” before any given song or feature (specific train car) is able to be heard or seen.

Programs scheduled at certain times and days are inconvenient for many consumers. The ability of each listener to tune in at any given time for a specific program is also a limitation as not everyone is available to listen at the same time. Traditional radio requires listeners to adjust their personal schedules to accommodate the programming schedule. Despite the vast capabilities of the medium, live streaming content on the internet such as radio station streams and pre-scheduled programs also burden the listener in the same way.

Downloadable internet audio content is immediately available to all users at any given time. Each person can hear exactly what they want exactly when they want it. Using the visual analogy of a train from the radio overview, this would appear as an infinite number of train cars with each one being immediately accessible at any time, so no waiting is required. In addition, the content is always available, which maximizes its convenience for each individual.

While this seems to overcome the delivery limitations of traditional radio, it also burdens the listener with having to find the desired content. Whereas radio provides a completely passive listening experience, downloadable internet content requires some “gathering effort”.

By far, the most common use of portable media devices such as Apple's “iPod™” and Microsoft's “Zune™” players are for playback of downloaded music. The advantage over traditional radio for the user is immediate access to customized content (“All your favorite songs right now”). The disadvantages compared to traditional radio include the time and effort required to compile the music “gathering effort” and the lack of spontaneous content, i.e., news, weather, surprise songs, announcer comments, etc, that are hallmarks of radio's ability to inform listeners and provide a form of companionship (relating to the announcer).

Regardless of whether the television content is obtained from cable TV, satellite TV, traditional airwaves broadcast, or internet streaming, the issue again is programming as the user must adjust his schedule to accommodate the content provider's schedule. There has been some relief in this area with the introduction of TIVO and DVRs. But each of these solutions has their own inconveniences such as you must be physically in their vicinity to program their recording schedules or to view the recorded content. Thus the television industry is presenting similar burdens to the consumer in that one must accommodate the television programmer's schedule to receive content.

### BRIEF SUMMARY OF THE INVENTION

It is an object of this invention to provide a system and method for the creation of a personal radio or television station for content broadcast and reception over the Internet.

It is another object of this invention to provide an interface for controlling the personal station that can be accessed from almost any location on the planet.

It is still another object of this invention to protect copyright holders from unlicensed use of their creations.

It is another object of this invention to provide security for any content that is distributed over the Internet so that it may not be copied or duplicated in an unlicensed or illegal manner.

It is an object of this invention to secure the appropriate licenses from any legitimate authority so that digital content may be distributed and enjoyed by many persons over the Internet.

It is a further object of this invention to allow consumers to select content from a variety of providers and to schedule such content delivery according to personal preference.

It is still another object of this invention to provide a method for developing and delivering self developed content over the internet.

It is even further an object of this invention to provide a personalized live studio broadcast to consumers over the internet.

### BRIEF DESCRIPTION OF THE SEVERAL VIEWS OF THE DRAWING

FIG. 1 shows a schematic diagram of the personal broadcast station invention;

FIG. 2 is a screen shot of the Login webpage of the personal broadcast station;

FIG. 3 is a screen shot of the Player webpage of the personal broadcast station;

FIG. 4 is a screen shot of the Music Collection webpage of the personal broadcast station;

FIG. 5 is a screen shot of the News webpage of the personal broadcast station;

FIG. 6 is a screen shot of the Weather webpage of the personal broadcast station;

FIG. 7 is a screen shot of the iNetRadio preformatted radio stations webpage of the personal broadcast station;

FIG. 8 is a screen shot of the Traffic webpage of the personal broadcast station;

FIG. 9 is a screen shot of the Emergency Alert System webpage of the personal broadcast station;

### DETAILED DESCRIPTION OF THE INVENTION

A portion of this disclosure is directed to a web-based radio station controlled by a user. The term “iNetRadio” is used to describe that particular embodiment of the invention. Therefore the ‘iNetRadio’ name is synonymous with the invention as directed solely to the delivery of audio content over the Internet. However, the same concept and methods are equally applicable to the delivery of video content over the Internet, i.e., “iNetTV”. It should be understood that the invention is directed more towards the user's ability to control programming and delivery of internet media, as well as select or control access to others, than it is about the actual file types (audio vs. video) being delivered. In fact a user will have the ability to ‘stream’ any file type available for transport by Internet protocols to any consumer through his personal Internet broadcast station.

This invention comprises a fully personalized web-based radio station that is programmed entirely by each user. iNetRadio is each user's “personal” radio station streaming music, news, custom messages and announcements, and other content via the internet. iNetRadio system uses a common database of music, news, and other content that can be selected for playback on each user's radio station. Each user is assigned their own stream which can be programmed to play their chosen songs in any order or randomly, with news, sports, weather, and user-provided content also added according to a schedule selected by the user.

Users are given a free webpage that they can use as a homepage for their iNetRadio stations and customize with text, pictures, and links similar to the structure of a MySpace.com™ site. Instead of a “friends” section as MySpace features, the user's iNetRadio homepage will feature a “listeners” section as well as a message board where listeners can talk about the station. Users can creatively set up their iNetRadio pages as they choose and use the pages to describe their stations.

iNetRadio is designed to overcome the limitations of all current media. By giving each user their own internet based “channel”, iNetRadio becomes a completely customized content delivery system. iNetRadio channels are for the use of the users, but can be heard by anyone if desired. Users can select exactly the songs they want to hear in addition to adding fresh content in the form of newscasts, weather, sports, traffic information, or specialty programs at any time.

Basically, iNetRadio is an internet station that each user programs as they desire complete with all the elements offered by traditional radio as well as content available on the net.

iNetRadio's content comes from internet based music databases, such as iTunes™, as well as music submitted by the users for their own use which is shared among all users. This creates an enormous database of music that can be shared, but not downloaded. News, weather, sports, traffic information, and specialty programs are made available from participating providers of such content.

The user is able to program their own iNetRadio stream by choosing the music they want to hear in any order or randomly, and selecting the add-on content (news, weather, etc) to run at any interval or at fixed times. Customized announcements by the user can also be added and scheduled to run at any time. This gives a completely individualized element to the iNetRadio product, allowing users to “DJ” their own stations if they choose, or to send greetings and other messages for their friends to hear on their iNetRadio channel.

iNetRadio channels can be accessed anywhere an internet connection is available by any networked or wireless device that can play an audio stream.

iNetRadio derives timely programming such as news, weather, sports, etc through agreements with participating content providers (NBC, ABC, ESPN, Metro Traffic, etc) where customized content is made available to iNetRadio users. Other specialty programs are made available from participating internet based content providers. These could include specialized music programs, news from other countries, or any content that is made available for inclusion by the originators for iNetRadio distribution.

Emergency information (EAS) sources are continually monitored for new alerts and such information is distributed in accordance with each iNetRadio station settings and geographic relevance.

Custom programming supplied and selected by the users is uploaded and stored for playback as specified by the users.

“iNetRadio Announcer”: Some users may want to have their songs announced in addition to having the title, artist, and album information displayed on the iNetRadio player and their iNetRadio website. A computer generated announcer using speech synthesis programming, either male or female, can be selected to announce the songs and other program elements just as would be heard on a traditional radio station. The language used by the iNetRadio Announcer could also be chosen to suit each listener or set to one language by the iNetRadio station user.

With the radio industry trend toward playing only thoroughly researched music, record labels are having an increasingly hard time getting new releases played on traditional radio stations. New music sales suffer from lack of exposure to consumers. The iNetRadio process includes a marketing plan for record labels where emails are sent out to iNetRadio users announcing new releases and their availability to be heard as early as a predetermined “release date and time”. Users who opted to receive such announcement emails based on genre or style would have the option to add the new music to their stations. Revenue would be derived from marketing and distribution of new music in this manner for record labels.”

The center of the iNetRadio system is a server that collects and stores the programs from their sources along with user selected music for playback on each user's channel as each user programs. Also stored on the server is content uploaded by the user including audio, text, image, and video files. It should be noted that not all content is stored on the server as some content is streamed in real-time format from 3^{rd} party content providers such as the EAS system, news or live sporting events. Also the user may upload any file format transportable over the internet, including file formats currently unknown as of today.

New users set up their iNetRadio channel by coming to a site such as http://www.inetradio.com and selecting the type of program they want. iNetRadio can be as simple or elaborate as the user desires and is limited only by the imagination. iNetRadio stations can be set to “private mode” and only accessible by the user and or whomever he grants access to. Or the station may be set to “public mode” and accessible by anyone who ‘tunes’ in to the user's webpage.

Music selection: Music can be added to an iNetRadio station in several ways. The easiest method is to choose from a number of preselected formats where the music is grouped by genre. The user merely has to choose from the list of formats where the songs are already picked. For users who have more specific tastes, music can be uploaded by the user or chosen from a constantly growing catalog of music made available from partner sites as well as shared music uploaded by all users and scheduled to run at anytime or constantly in any order or randomly. Just as with traditional radio, music can be “dayparted” with different songs set to playback at different times of the day or night. This advanced feature would allow users to create mixes for special events such as parties or certain music to help wake up or get to sleep.

Information: News, weather, sports, or even local traffic information can be selected from a choice of participating providers and can be scheduled to automatically play either at an interval, i.e., every 30 minutes, or at fixed times. These sources would begin playback at the conclusion of the last song played as close to the scheduled time without cutting off a song or other preceding element. Users could create an all-news and sports channel simply by not selecting any music and choosing the desired sources.

Custom Announcements: These truly make the iNetRadio experience unique and fun for those who want to “host” their own channel. Users can record their own announcements and schedule them to run at any time. These could include announcing their own songs, sending greetings to friends, or presenting their own newscasts.

Customized iNetRadio homepage: Each iNetRadio user is given a web page to set up as they see fit. This is the page that visitors see when they access the station and is the launch site for the iNetRadio player. Each site is as unique as the user makes it and includes text and images as well as a “listeners” area and a message board if the user chooses.

iNetRadio Content Sources:

Music—Alliances with internet music database sites such as iTunes and record labels (U.S. iNetRadio stations only as copyright laws allow). Users can upload their own music whether purchased or original, such as local bands.

News—Customized headline news clips from participating news providers such as ABC, BBC, CBS, CNN, IRN, MSNBC, and NPR in exchange for branding.

Sports—Customized sports reports from participating sports providers such as ESPN, NFL, NBA, MLB, NASCAR, FIFA, WWE, and NHL in exchange for branding. Long form content such as games or other sporting events would be offered inclusive of advertising content from the providers.

Weather—Local weather reports from The Weather Channel/weather.com based on zip codes entered by users and “Local Weather ID” codes used by The Weather Channel. Condensed audio would be similar to the “Local Weather On The 8s” synthesized audio but without the background music as heard on The Weather Channel.

EAS (Emergency Alert System)—National, regional, and local alerts, including Amber Alerts would be provided via an IP-based distribution system currently being developed (2008) to replace the existing “station chain” model. EAS content is user selectable and immediately overrides streaming content.

Special Features—There is a rapidly growing source for both specialty talk and information shows as well as new releases made available from record labels. Users can sign up to receive email announcements describing new music or programs that can be added to their iNetRadio stations. Concerts, celebrity interviews, latest music releases, and talk shows all fall within this category and can be instantly chosen by the users by clicking on the associated links within the emails.

Custom Content—Users can upload their own custom content that they want to feature on their iNetRadio stations. This could include announcements, speeches, home-made ads, greetings, their band's most popular tracks, podcasts . . . anything! These can virtually be of any length and are uploaded from the user's computer. Users can also make recommendations by submitting a link or website for review.

The user also has the ability to choose what plays first when the listeners tune in. For example, a greeting could play, welcoming the listeners to this great station or the latest news could begin the broadcast.

Master Station Override—In certain limited cases such as a national emergency, natural disaster, or government mandate, all user programming would be cancelled and each user station would broadcast an override message in accordance predetermined rules for such.

iNetRadio gives users three options for selecting their type of channel. The first option is a free channel where short commercials are automatically inserted into the stream by the iNetRadio system. This would create a very radio-like experience except that the user is the program director and music director. The second option is a commercial-free channel that would require a nominal monthly fee. The third is the commercial option and is intended for business applications.

Commercial content consists of :15 second, audio-only commercial “spots” or “ads” in addition to banner ads that appear on the custom iNetRadio player as well as on each iNetRadio station's home page. Ad placement is determined by the user-provided Zip Code information and their internet connection location. Locally relevant commercials will only play in the areas that the advertiser purchases, while advertisements for national advertisers will be placed with less geographic specifications. Additional information about the users, such as age, gender, race, and even interests is derived from the iNetRadio users web pages can be used to further target market specific commercial content.

As an option, users can “buy out” the ad content for a commercial free version of an iNetRadio station by paying a monthly subscription fee.

A commercial version of iNetRadio is available to restaurants, bars, stores, resorts, and other businesses that want a customized and controlled audio source. This version does not include service elements such as news, weather, traffic, etc, except by special arrangement and is automatically a “Private mode” station and cannot be heard by the general public. It is the current intent to have the content heard at the place of business as opposed to distributed to an audience on the net. The commercial version can be distributed to an entire franchise with adjustments for time zone changes, hours of operation, language changes, various marketing campaigns based on geographical location, and cultural differences to cite a few examples.

Listeners to iNetRadio stations have the option to purchase content that they like. A “BUY” button on the iNetRadio players begin an e-commerce session for the purchase of the song, for example. iNetRadio receives a commission for each song purchased through this method.

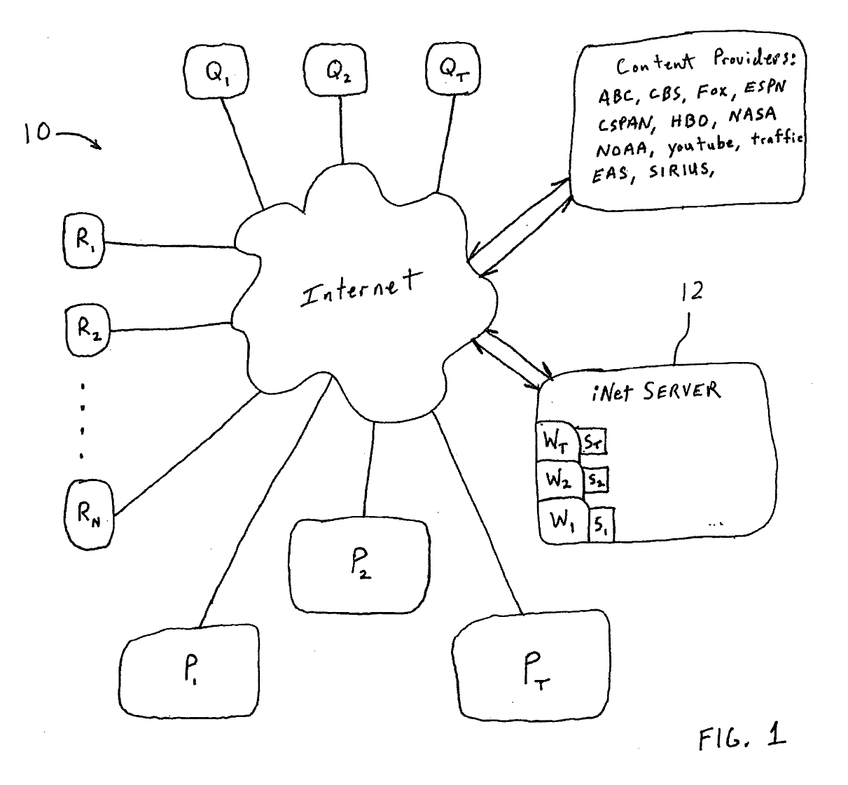

Referring now to FIG. 1 a schematic block diagram of the present invention is shown. The user programmable Internet broadcast system 10 comprises a user P₁, P₂, or P_{T}, where the subscripts 1, 2, through T indicate any number of unique users, who gains access to the iNet Server 12 over the internet using his personal computer or other internet access device (e.g., Blackberry™, WebTV™, cellphone, laptop computer and wireless card). The user P₁, P₂, or P_{T} creates a personal account on the iNet Server 12 and is issued a unique ID and password. The user's ID is assigned to a unique webpage(s) W₁, W₂, or W_{T}, and each webpage further has assigned to it, a unique memory storage S₁, S₂, or S_{T}. The user P₁, P₂, . . . P_{T} then creates a ‘play list’ of programming by selecting content from any one of a long list of providers that the iNet Server 12 has secured a license with for content use and rebroadcast. The content may be solely audio including music, live news, sports, traffic or any other audio content available on the web. The content may also be video from news outlets such as Google, AP, or Reuters for example; or other video/image sources such as YouTube, Flickr, or Google images for example; archives or from live broadcasts from the content providers, or it can be a mixture thereof. Once the content is selected by the user P₁, P₂, or P_{T}, he then assigns play times and frequencies for each content piece. Thus the user P₁, P₂, or P_{T}, has created his own personalized program.

The user P₁ may also upload content for storage on the server 12 and assign such content to his play list. That content can be any file type usable on the Internet by common audio or video streaming players. For example the user may upload his own personal music files from his computer. He may also upload video files in any of the commonly known formats. These files are stored on the server 12 in the storage space assigned to the user P₁. Any of these various files may then be included in the users playlist. Because content delivery by the server 12 is limited to ‘streaming’ methods and protocols, peer-to-peer file sharing and copying is eliminated.

A further embodiment is a live broadcast in which the user P₁, P₂, or P_{T}, uploads real time ‘live’ audio, video or both for immediate broadcast over his webpage W₁, W₂, or W_{T}.

Once the user's have created their unique programming, they can command their webpage into broadcast mode. There after, groups of other internet receivers R₁, R₂, or R_{T}, or Q₁, Q₂, or Q_{T}, may ‘tune in’ to a selected webpage by pointing their browser or audio player to one of the live webpages W₁, W₂, or W_{T}. A user P₁, P₂, or P_{T}, can allow his webpage to be accessed by anyone on the internet or he can limit such access to a select group by requiring such consumer to follow an access protocol such logging in with an ID and password.

It should be noted that this invention is wholly scalable and the number of users P₁, P₂, or P_{T}, receivers R₁, R₂, or R_{T}, and iNet Servers (including mirrors) is not theoretically limited.

Certain programming interrupt priorities may be set by the user in accordance with selected parameters such as geographic locations, keywords, famous names, and or specific events such as weather conditions, news and traffic alerts, financial and business information.

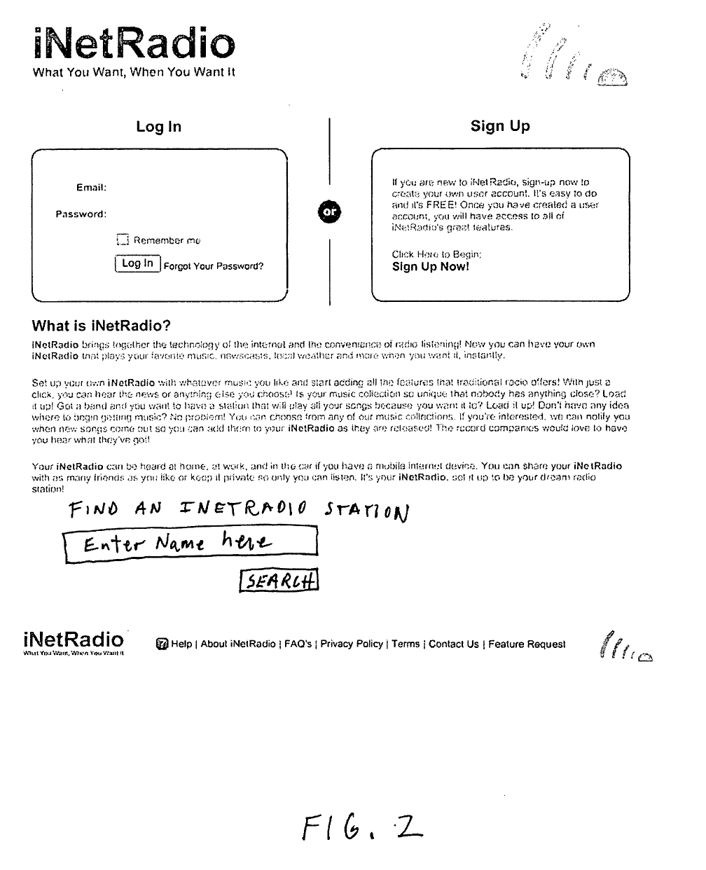

Referring now to FIG. 2, a screen-shot of the iNetRadio ‘Home Page’ is shown as displayed on an Internet browser such as Firefox or Safari. On this webpage a user can either 1) login, 2) sign up, or 3) search for an existing iNetRadio station. The user can find an existing iNetRadio station by entering a search term, or by default find a list of all existing stations; or the user can enter his email address and password to login to a previously created account; or the user can click on a radio button to begin the registration process.

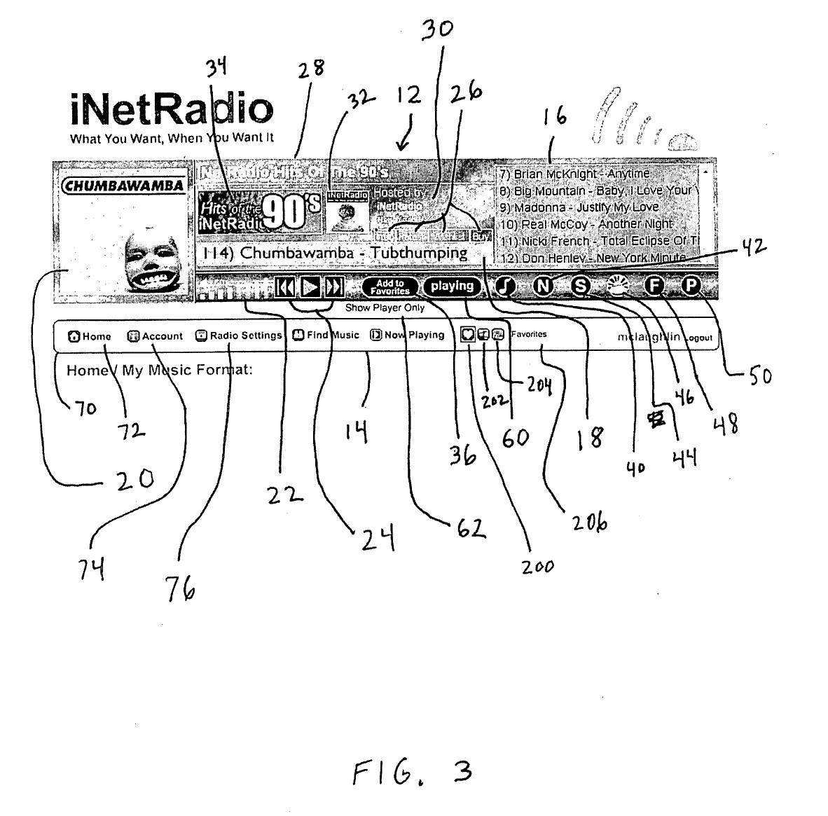

Referring now to FIG. 3, a top level webpage for the iNetRadio station is shown including a player 12 and the menu bar 14. The player includes several elements. The users playlist 16 displays a list of the selections that the user has assembled into his current playlist. The items in the playlist 16 are numbered in numerical order starting with the number one. The list ascends a numerical order and determines which audio file will be played next. The current selection being played is highlighted in the play list 16. The title of the currently selected item is displayed in the now playing bar 18. Artwork or other visual logos or trademarks are displayed on the left side of the player 12 in the artist window 20. A volume control bar 22 is operable by using a conventional mouse pointer in a click and drag mode. In this manner the audio volume heard through the listener's speakers may be increased or decreased as desired. Three clickable player control buttons 24 may also be operated by a mouse pointer. These controls may be used in a conventionally known manner to start the audio track, pause the audio track, rewind the audio track, or fast forward the audio track. For pop-up tabs 26 are provided to perform operations on the currently playing audio track. When selected by the mouse pointer the first tab “Info” provides descriptive information associated with the audio file. The second tab “Rate It” allows the user to record his rating of the selection. The third tab “Wish List” adds the currently playing selection to a wish list of the user. The fourth tab “Buy” causes a pop-up window to be displayed that includes a list of hyperlinks to virtual retail stores on the web which sell the currently playing item, such as iTunes or Amazon.com.

In the particular configuration shown in FIG. 3, a ready-made playlist has been selected from the server as is shown in the display bar 28. The “iNetRadio hits of the 90s” includes a previously assembled list of music which the user had selected.

The location of the particular server is displayed in the server information window 30. It can be seen that this particular server is being hosted in New York city, N.Y. And avatar 32 is displayed next to the server information window 30. The avatar 32 is selected by the content provider can further assist to identify the source of the audio files. A logo window 34 is provided to display any trademark associated with the content provider.

An “Add to favorites” radio button 36 is provided so that the user may add the current audio selection to his personal favorites list.

Six additional radio button are provided on the lower right side of the player 12. These buttons comprising a musical note 40, an ‘N’ (News) 42, an ‘S’ (Sports) 44, a rising sun (Weather) 46, an ‘F’ (Features) 48, and a ‘P’ (Programs) 50, function in a manner similar to the mechanical buttons on a car radio in that they take the listener to a preselected location.

Upon selection of the musical note button 40, the play list window 16 becomes populated with any of the available iNetRadio stations including preset playing lists provided by the server or iNetRadio stations configured by other users.

Upon selection of the news button 40, the playlist window 16 displays all of the news feeds that have been selected by the user as described below. The user can go directly to any of the news feeds in the playlist window 16 by selecting them with the mouse pointer in a double-click manner.

The remaining preset buttons, Sports 40, Rising Sun 46, Features 48, or Programs 50 when selected by the mouse pointer will display the users preconfigured selections in the playlist window 16. Again the user may select any item displayed in the playlist window 16 for immediate audio consumption by double-clicking the item of interest in the playlist window 16.

To return from any of the above preset displays and identify the currently playing audio file the user selects the Playing 60 radio button. This navigates the user's playlist window back to the current playlist.

Just below the player is a clickable button 62 which toggles any content displayed below the player on or off in terms of being visible on the user's browser.

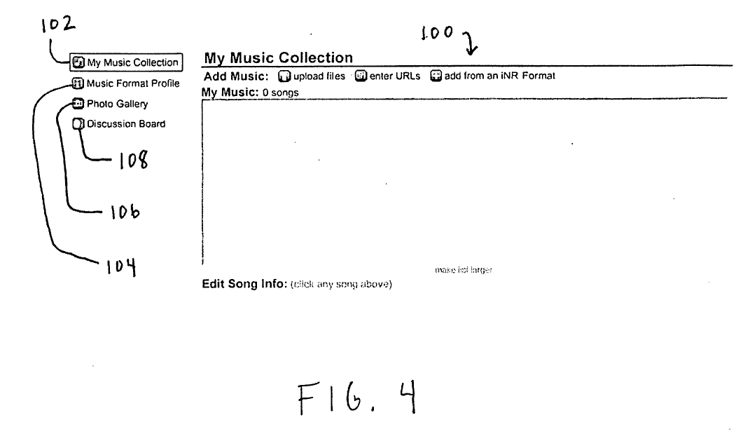

Just below the player is a menu bar 70. Contained in the menu bar 70 are mouse clickable icons and text. The Home 72 button provides a display as shown in FIG. 4 below the player 12 and menubar 70.

A pulldown list 206 is shown in the menu bar 70. The list contents are selected by clicking on any one of the three icons to the left of the list 206. These icons are a heart-shaped favorites 200, a recently visited icon 202, and an iNetRadio list 204. When any one of these three icons, Favorites 200, Recently Visited 202, or iNetRadio 204 are selected, then the contents of the pulldown list 206 will be displayed when the user clicks on the pull down list 206. This provides a navigational shortcut for a user who has organized his station's by any one of these selections.

Now referring to FIG. 4, the users is music collection 100 is shown. In this location a user can upload songs or audio files; enter URL's from the Internet, or add songs from the iNetRadio playlist.

The user can further navigate in this sub menu window 100 by selecting any of the icons on the left side of the display. When the user selects the Music Format Profile 104, he navigates to another window where he can enter information pertaining to his radio station. For example he can enter his iNetRadio station Name (for textual display), the Spoken Name (for audio identification), the Tagline (for textual description), the Spoken Tagline (for audio description), Keywords (to assist a search engine in identifying and locating this particular radio station), a Genre selection such as Rock, Country or Classical to further describe the musical content; and an image, logo or trademark, all to be displayed, played or presented in another user's player window 12 when listening to this particular radio station. All of this information is unique to this particular user's radio station.

Further the user can select the Accessibility of the radio station. He may allow the station to operate in one of several modes: Public, Limited, or Private. In the public mode anyone on the Internet may access the radio station. In the limited mode only those specific listeners authorized are allowed access to the radio station. In a private mode only the creator of the radio station may access its content.

Further the user may delete the entire radio station using a Delete button. The delete function removes any and all files, playlists, personal information, and any other information or digital content that the user created, uploaded, linked, or stored on the server 12 in association with his identity and/or password.

Again referring to FIG. 4, a clickable button for a Photo Gallery 106, is shown. When selected the web browser navigates to a page where the user can upload/browse image files from his computer. This feature allows the user to display images on his radio station such as Avatars, logos, trademarks, including personal photographs.

Lastly in FIG. 4, a clickable button for Discussion Board 108, is shown. When the user clicks on the Discussion Board 108 button, he navigates to a comment page where he can't read and review comments by other users and furthermore he may enter his own comments.

Referring back to FIG. 3, an Account 74 clickable link is shown. When a user clicks on the Account 74 link, he navigates to a web page with fields allowing him to enter information regarding his personal Profile, Password, and optionally he may perform a Delete Account function. Further he may browse and upload images for display as Avatars. Multiple images may be uploaded and retained for selection as Avatars.

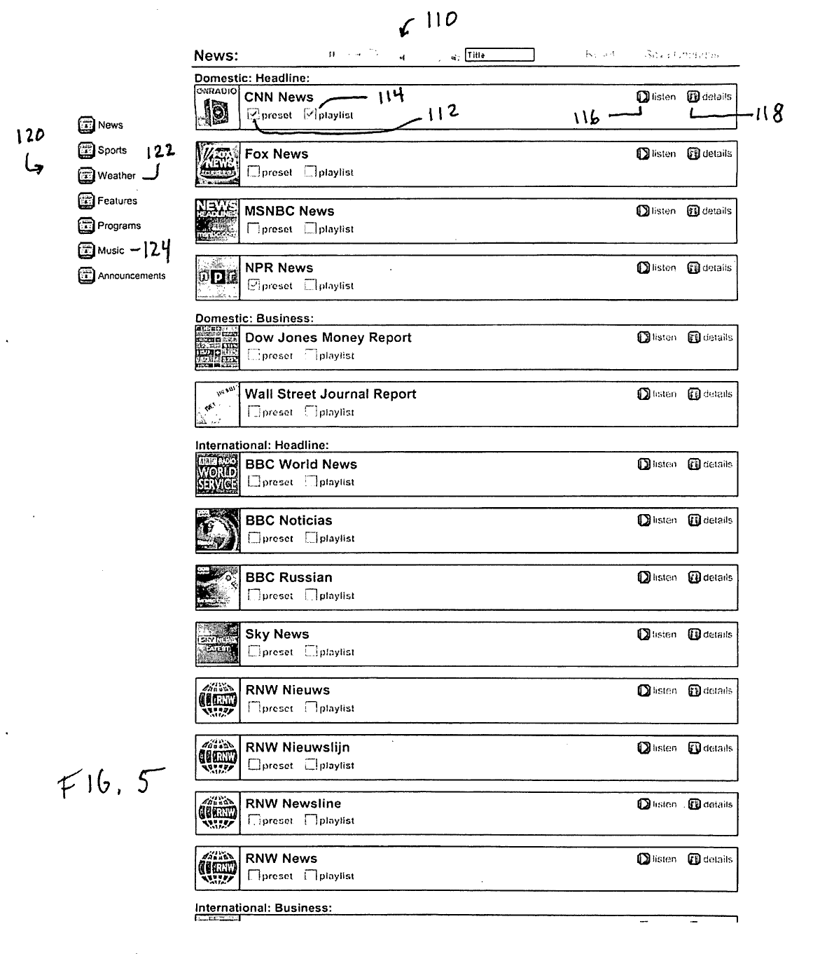

Further referring to FIG. 3, a Radio Settings 76 clickable link is shown. The Radio Settings 76 link navigates the user to FIG. 5.

Now referring to FIG. 5, a list of well-known news networks 110 is shown along with a set of clickable links 120 in the left margin. The first listed news link is for CNN News. In the CNN News bar is a clickable Preset box 112 and a clickable Playlist box 114. When the user selects the Preset box 112 in the CNN News bar it automatically adds the CNN News two the playlist which is displayed when the user clicks the preset button ‘N’ 42 as shown in FIG. 3. This feature of the Preset box 112 is an option available for all of the news feeds shown in FIG. 5. The user may configure which of these news feeds he wishes to have connected to his ‘N’ 42 button in FIG. 3.

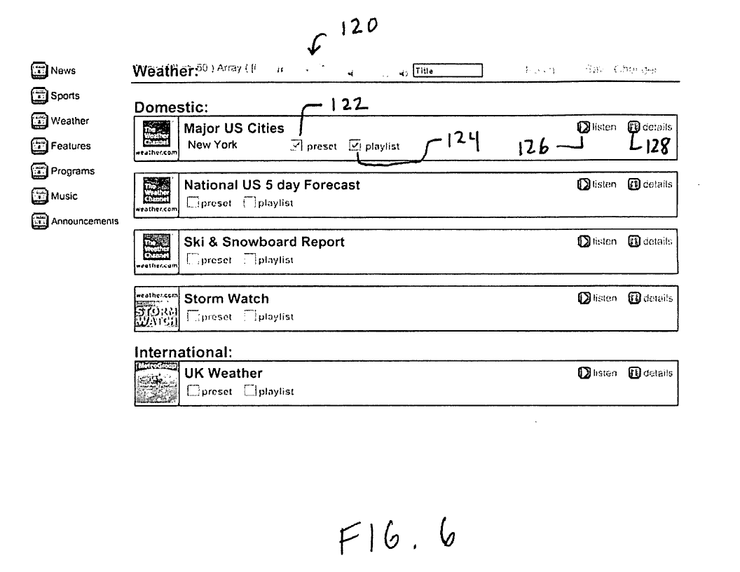

The Playlist 114 box may also be selected by the user and causes the selected newsfeed to be added to the users regular playlist 16 as shown in FIG. 3. The Listen button 116, may be clicked on to provide an immediate audio presentation of the selected newsfeed. In this manner the user may preview the particular news feed before he decides to add it to his Playlist 114 or his Preset 112. Further the user may click on the Details button 118, so as to review any particular descriptive information provided by the particular news feed organization. Next the user may select the clickable button Weather 122, which will navigate him to a display as shown in FIG. 6.

Now referring to FIG. 6, a list of weather feeds are shown. Again as was shown in FIG. 5, several clickable buttons are shown for each weather feed. In particular a Preset 122, Playlist 124, Listen 126, and Details 128 boxes/buttons are shown. The same feature set is operational for the weather feeds as was described for the news feeds in FIG. 5.

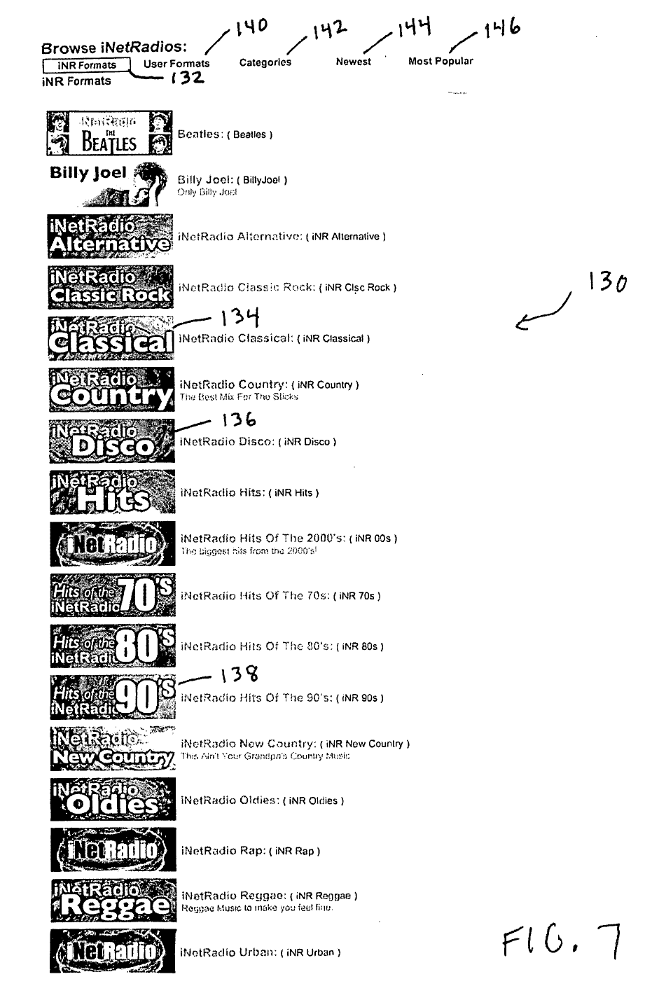

Now referring to FIG. 7, a list of iNetRadio stations 130 is shown. A user navigates to this display when he selects the Music button 124 as shown in FIG. 5. In FIG. 7, it should be noted that the ‘iNR Formats’ button 132 is highlighted. This indicates to the user that the displayed radio stations 130 are a predetermined set of playlists. As can be seen, different genres are shown such as Classical 134, Disco 136, or Hits of the 90s 138. By clicking on any of the logos such as Classical 134 or Disco 136, the user is immediately taken to the playlist of that particular collection.

The user may browse to other radio stations by clicking on the links at the top of FIG. 7, such as User Formats 140, Categories 142, Newest 144, or Most Popular 146.

If a user clicks on User Formats 140, he will be presented with a list of all other public iNetRadio stations created by other users. He may then click on any one of those other public radio stations and be immediately subscribed and listening to their programming. If a user clicks on Categories 142, he is presented with radio station formats in the following categories: General, Single Band, Party Mix, Dinner Music, Sleep Time, Work Day, Independent Bands, Workout, and Romantic. The programming on the server 12 takes all of the iNetRadio music stations, regardless of whether they are created by users or a predetermined playlist offered by the server, and organizes them in the above categories. For example if you were looking for a playlist that was comprised solely of music by Neil Young, you would click on the Single Band category and scroll down until you found your desired band. At the same time, it may be late in the evening and you are considering going to bed. You may be one of those people who likes to listen to relaxing music as you fall asleep. In that case you would select the Sleep Time category, and a list of radio stations that consider themselves to be compilations of music to fall asleep to would be presented, and the user could make an appropriate selection.

The Newest 144 and Most Popular 146 clickable buttons would present radio stations falling into those categories. The Newest button 144 would navigate to a webpage that presents a selection of the most recently created radio stations. The Most Popular button 146 would navigate to a webpage that presents a selection of the most popular radio stations as determined by how many users and or listeners have selected those stations for their play list.

Other clickable buttons (not shown) are Favorites, Visited, and Search. If the user selected Favorites, he would navigate to a webpage that presented a list of any radio stations he had added to his favorites list by selecting the Favorites button 200 as shown in FIG. 3. If the user selected Visited, he would navigate to a webpage that presented a list of any radio stations he had visited in recent history. Lastly, if the user selected Search, he would navigate to a webpage that presented him with search tools to find radio stations meeting any of the search parameters such as: category, genre, name search, and user ID.

Further the player 12 can be displayed as a floating pop-up window and has all the usual ‘window’ capabilities such as minimizing, dragging, and resizing. Keyboard shortcuts (F keys) can be used to perform these functions without the use of a pointing device (mouse).

The iNetRadio Player can be customized by the user depending on the desired programming options or “service elements”, chosen for the station. Service elements can include news, weather, sports, traffic, or any other content that is typically available on a traditional radio station.

As service elements are selected and programmed into the ‘radio station’ by the user, corresponding “radio buttons” (similar to station preset buttons on a radio) appear on the player. During use by a consumer, these buttons can be selected by clicking on them with a mouse at any time to select the next audio source. The selected button changes to a distinctive color such as yellow to confirm and indicate the selection. The selected element appears in the “Next Play” field of the display. If the user desires to hear the selected element immediately, the red “NOW!” button can be pressed (clicked), causing the current audio to be cut off and replaced by the selected element. Alternatively, a radio button can be double clicked for instant delivery of that button's particular content selection.

Example: If a song is playing and the listener desires to hear the latest news, the “NEWS” button would be selected (single mouse click). It would then “light up” in yellow, confirming the selection, and the latest available newscast would play at the end of the currently playing song. If the listener wants to hear the news instantly, he can either double click the radio button or he can select the red “NOW” button after one click on the news button, thus cutting off the song and presenting the news audio stream immediately.

If chosen by the user in the iNetRadio setup options, emergency information available from the Emergency Alert System (EAS) would automatically run on the iNetRadio stations the moment the information becomes available. Localized information would be directed to specific iNetRadio listeners based on their geographic location determined by their supplied Zip Code and internet access location (IP address and domain data).

The players can be launched from links as well as from each iNetRadio station site. The players remain in the foreground regardless of browsing activity unless minimized or closed.

The iNetRadio players can also feature a user provided “logo” that appears in the album art section of the display. This image would alternately display with album art and advertising visuals.

A ‘BUY’ button can be programmed into the player so that the end user can actually buy certain songs or programs that may be for sale and or download.

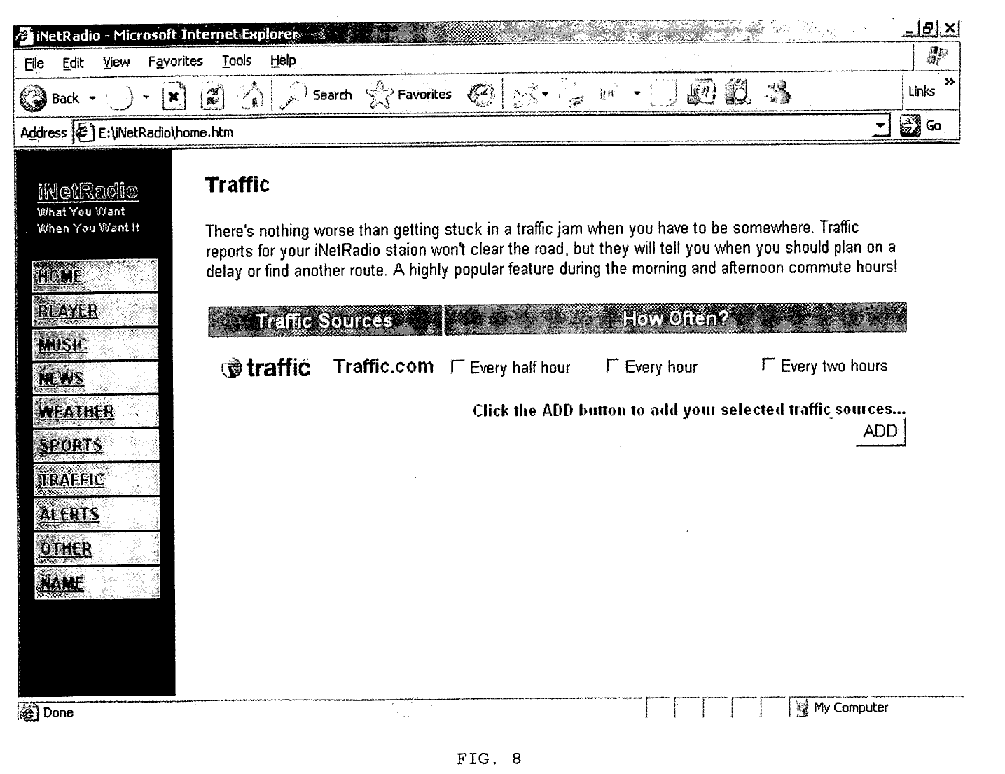

Referring now to FIG. 8, a ‘Traffic’ webpage is shown depicting the setup choices each radio station programmer is offered by the server. The programmer can select the traffic feed of his choice such as Traffic.com or local traffic information providers. The server can vary its programming options according to the zip code of the programmer or the zip code of the intended listening audience (location information can be provided in many other ways besides zip code). It is an option that is provided to the programmer as to whether he wants certain kinds of information to be location specific and how great a zone of coverage he prefers. For example traffic news could be only for a certain city or it could be for a larger area such as a state or region such as NYC which would include bridge and tunnel information. He then selects the frequency he would like to have the weather aired on his station such as every 30, 60 or 120 minutes. He next clicks the “add” button to put them on his station playlist. Other time intervals may be programmed into the server as well.

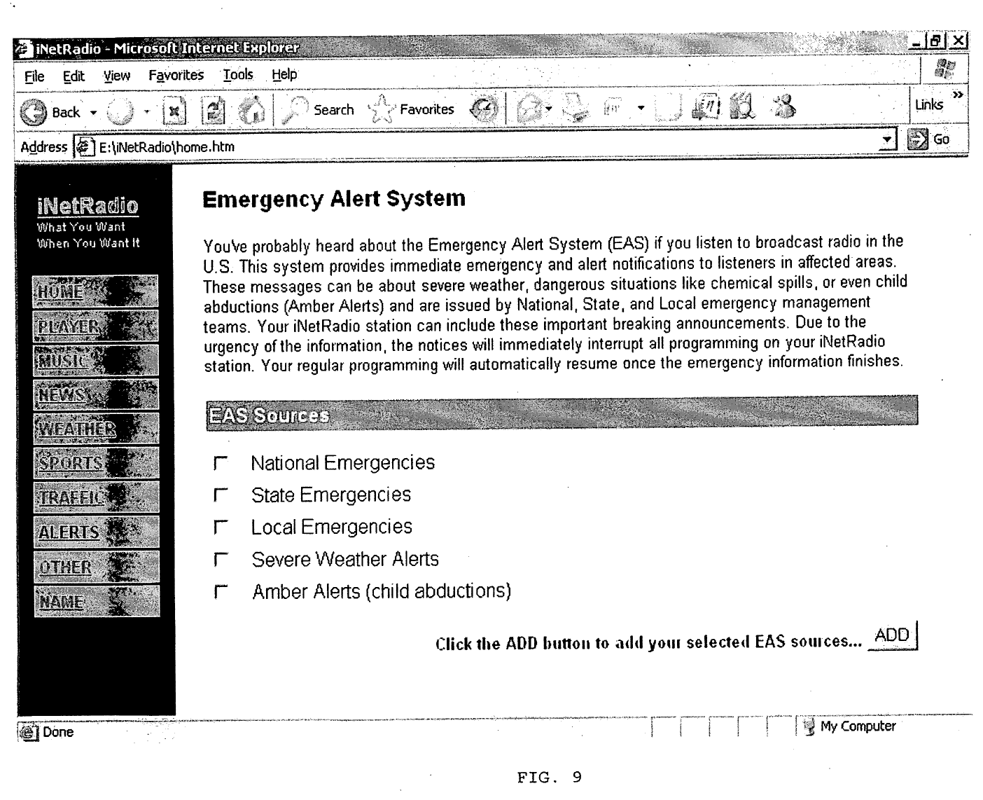

Referring now to FIG. 9, an ‘Emergency Alert System’ (EAS) webpage is shown depicting the setup choices each radio station programmer is offered by the server. The programmer can select single or multiple types of emergency feeds of his choice such as National Emergencies and/or Amber Alerts. There is no frequency selection here as this information usually overrides any and all other broadcast information. He next clicks the “add” button to put them on his station playlist.

The iNetRadio server also has the capability to override any and all broadcasts at anytime regardless of the programmer's selections for extremely serious matters such as National Defense or tornado warnings.

Although not shown, a Suggestion webpage is included in the website with entry fields for user input regarding other selections or programming that the user would like to see. The user can also add other audio file sources from his own computer or from the internet at large and set a frequency for such programming to air on his station. He next clicks the “add” button to put them on his station playlist.

Copyright protection: The server will implement various copyright protection schemes to ensure that unlicensed copyright protected materials are not being broadcast through its server. This includes articles, photographs, videos, text and music. In particular it is well known that musicians and music companies depend on revenue streams from their licensed products. This invention obviates the need for digital rights management (DRM) tools or protocols because no audio file or video file is ever downloaded onto a listener's or users computer. The audio or video file is presented to the user's computer in a well known ‘streaming mode’ whereby the file is never assembled as a whole on the users computer. Instead, the file is transmitted in segments whereby each segment is played on the users computer and then discarded. As the computer reaches the end of a particular segment, it then requests the next segment from the server. As each segment is played and then subsequently discarded, a complete audio or video file is never downloaded or assembled on the users computer.

We claim:

1. A method for programming media content for delivery over the internet comprising the steps of:
creating a unique identifier for accessing a personal account on an internet server;
assigning a unique webpage address to said personal account;
creating a personal playlist associated with said unique webpage and selecting at least one media content from a server list;
wherein anyone who accesses said webpage address will receive said media content delivery automatically and continuously.

2. A method as in claim 1 and further comprising the steps of:
selecting content from any of several categories including commercial news feed, weather feeds, music lists, sports feeds, traffic reports, emergency broadcast announcements.

3. A method as in claim 1 and further comprising the steps of:
scheduling predetermined periodic broadcasts of selected content.

4. A method as in claim 1 and further comprising the steps of:
the server overriding the user selected programming with emergency broadcast programming.

5. A method as in claim 1 and further comprising the steps of:
the users selecting a mode of operation from at least one of a private mode or a public mode;
wherein only user approved listeners have access to said users broadcast station.

6. A method as in claim 1 and further comprising the steps of:
the server operating in a commercial free mode or commercial mode;
the user choosing either mode of operation and paying a fee for said commercial free mode;
said commercial free mode allowing said user to control the programming of his station within certain operational rules;
said commercial mode being available to said user for no fee and said user's programming output is interlaced with server selected commercials for broadcast over the user's station.

7. A method as in claim 1 and further comprising the steps of:
providing a live mode to each user;
said user creating live content in a private studio;
said live content being uploaded to the server in real time;
said live content being further distributed by the server to listeners over the internet in real time;
wherein the listeners experience a live broadcast under the programming control of said user.

8. A method as in claim 1 and further comprising the steps of:
selectively tagging any and all files on the server for copyright protection;
preventing sharing and broadcasting of said copyright protected files by users beyond the specified limitations of their licenses.

9. A method as in claim 6 having a third mode of operation, further comprising the steps of:
selecting a corporate mode for said broadcast station;
providing programming content in accordance with said corporate guidelines;
said content containing selective message content depending upon the location or market of each corporate location;
wherein said corporate content is distributed over selected corporate communication channels including internet and selected audio and video outputs.

10. A method as in claim 1 and further comprising the steps of:
providing content selection from audio or video materials or a combination thereof.

11. A system for configuring and delivering user programmable media content over the internet comprising:
a dedicated server in communication with the internet;
a user's device in communication with the server over the internet;
a program executing on the server and selectively communicable with the user;
the server having a selectable database of media content in retrievable storage;
an index of the database content presentable by the server to the user;
a program executing on the user's device for displaying said index to the user in a configurable manner and the user creating and storing a playlist;
upon user command the server broadcasting the content on the user playlist to the user without downloading the entire media file to the user's device.

12. The system as in claim 11 and further comprising:
a commercial download controller executing on said server and being in communication with at least one of a plurality commercial media outlets on the internet and automatically and periodically downloading updated content from said at least one of commercial outlets;
an update module operating on the server for updating server playlists with recently downloaded content from said commercial servers;
wherein said updates are included in user's playlists who have subscribed to the commercial servers.
